(19) United States
(12) Patent Application Publication
(10) Pub. No.: US 2026/0225518 A1
(43) Pub. Date: Aug. 6, 2026

(54) SYSTEMS AND METHODS FOR ENHANCED VEHICLE VISUALIZATION

(71) Applicant: Ford Global Technologies, LLC, Dearborn, MI (US)

(72) Inventors: Mahmoud Yousef Ghannam, Canton, MI (US); RAMI AL KHATIB, Dearborn, MI (US); John Robert Van Wiemeersch, Novi, MI (US); Austin Michael Gorowski, Maybee, MI (US)

(73) Assignee: Ford Global Technologies, LLC, Dearborn, MI (US)

(21) Appl. No.: 19/046,125

(22) Filed: Feb. 5, 2025

(51) Int. Cl. B60Q 1/50; H05B 47/125

(52) U.S. Cl. CPC B60Q 1/543; H05B 47/125; B60Q 2400/50

(57) ABSTRACT

Systems and methods for enhancing visualization of a vehicle are provided. It may be often hard to identify and/or locate a specific vehicle in crowded locations such as airport parking lots, event venues, etc. This disclosure provides systems and methods that can help users easily and reliably locate a specific vehicle from among multiple vehicles. When the vehicle and the user are within a threshold distance of each other, the user may send a message to the vehicle via his/her user device. The vehicle may activate its display control module based on the message. Thereafter, the vehicle then may operate a display device of the vehicle to output a visual indication that includes unique identifying information that is only known to the user. The user can view/see the visual indication from outside of the vehicle from a distance and use that to locate the vehicle.

### FIELD

The present disclosure relates to the field of vehicle identification. Specifically, embodiments of the present disclosure relate to methods and systems for enhancing a vehicle's visibility so that a user can easily locate the vehicle from a distance in various environments.

### BACKGROUND

It may sometimes be difficult for a user to spot the right vehicle in areas where there is large vehicle density, such as a parking lot. In other instances, a user may have an issue with identifying the correct vehicle when multiple vehicles of similar make and model are closely located, such as at a ride hail pick spot at an airport or outside a large event location.

There are several reasons why a user may have difficulty identifying the correct vehicle. Lack of distinct visual cues on the vehicles can contribute to the difficulty. The presence of multiple vehicles of the same make, model, and color in the same location may make it harder for a user to identify the vehicle for which he/she is looking. A user may park his/her car in a large parking lot and forget the exact place where he/she has parked. The place where the user parks his/her vehicle may have poor signage or confusing layout making it hard to mentally bookmark the location of the parked vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle according to an embodiment of the present disclosure.

FIG. 3A illustrates an example environment/scenario in which the embodiments of the present disclosure may be implemented.

FIG. 3B illustrates another environment/scenario in which embodiments of the present disclosure can be implemented.

FIG. 3C illustrates yet another environment/scenario in which embodiments of the present disclosure can be implemented.

FIG. 4 a data flow sequence of a process for enabling a user to locate a vehicle according to an embodiment of the present invention.

FIG. 5 illustrates a flow diagram of a process according to an embodiment of the present invention.

FIG. 6 illustrates a flow diagram for a process according to another embodiment of the present disclosure.

FIG. 7 illustrates a flow diagram of a process 700 according to yet another embodiment of the present disclosure.

FIG. 8 illustrates a block diagram of a server according to an embodiment of the present disclosure.

### DETAILED DESCRIPTION

### Overview

The present disclosure describes systems and methods for enhancing visualization of a vehicle. Specifically, embodiments of the present disclosure relate to the vehicle outputting unique identifying information that is visible from outside the vehicle. The unique identifying information is only known to the vehicle and the user who is trying to locate the vehicle. Embodiments of the present disclosure provide a method for enhancing a vehicle's visibility to a user. The method may include determining a first location of a vehicle, determining a second location of a user device, determining, based on the first location and the second location, that the vehicle and the user device are within a threshold distance of each other, determining unique identifying information, and outputting, via a display device of the vehicle, a visual indication that can be seen from outside the vehicle, the visual indication including the unique identifying information. The method may further include prior to outputting the visual indication, receiving, by the vehicle from the user device, a message to activate a display control module of the vehicle, and activating, by the vehicle and based on the message, the display control module. Outputting the visual indication may further include operating, by the display control module, the display device of the vehicle.

In another instance, a method is provided that may include determining a first location of a first vehicle, determining a second location of a second vehicle, determining, based on the first location and the second location, the first vehicle and the second vehicle are within a threshold distance of each other, establishing a communication session between the first vehicle and the second vehicle, outputting, by the first vehicle, a first visual indication including first unique identifying information that is visible from outside of the first vehicle, and outputting, by the second vehicle, a second visual indication including second unique identifying information that is visible from outside of the second vehicle.

In yet another instance, a vehicle is provided that may include a controller, a display control module coupled with the controller, a display device coupled to the display control module, one or more sensors coupled to the controller, and a memory device coupled to the controller. The memory device may store instructions that, when executed by the controller, cause the controller to determine a first location of the vehicle, receive, based on the first location, a message from a user device to activate the display control module, activate, based on the message, the display control module, and output, based on the message and using the display device, a visual indication that can be seen from outside the vehicle, the visual indication may include unique identifying information.

These and other advantages of the present disclosure are provided in detail herein.

### Illustrative Embodiments

The disclosure will be described more fully hereinafter with reference to the accompanying drawings, in which example embodiments of the disclosure are shown and not intended to be limiting.

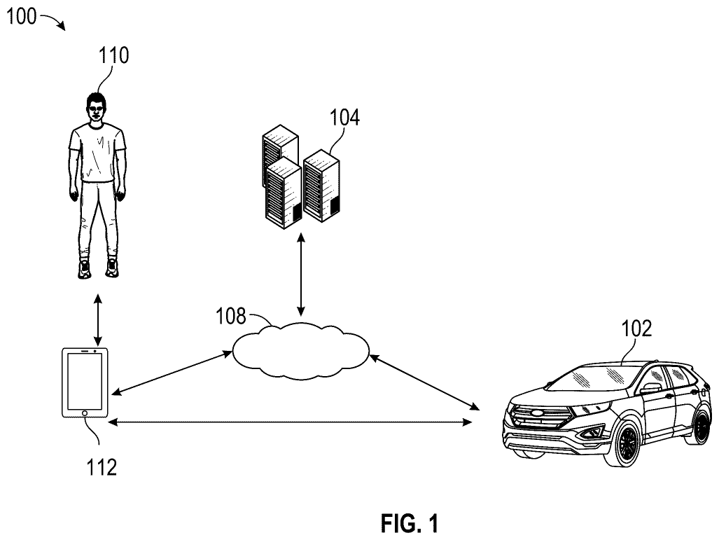

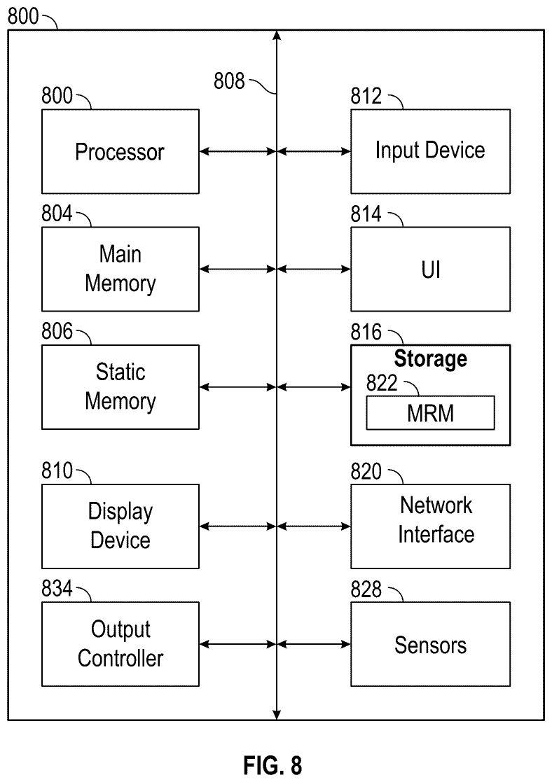

FIG. 1 illustrates an environment 100 in which the embodiments of the present disclosure may be implemented. The vehicle 102 can be any passenger or commercial vehicle such as a car, truck, tanker, bus, or the like. The environment 100 may also include a control server 104. The control server 104 may be part of a cloud-based computing infrastructure and may be associated with and/or include a Telematics Service Delivery Network (SDN) that provides digital data services to the vehicle 102. Details of the control server 104 are provided below with reference to FIG. 8.

The environment 100 may also include a user device 112. The user device 112 may be one of a mobile phone, a tablet, a personal computer, a smart key fob, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle-generated information and other control data. In one embodiment, the vehicle 102 may communicate directly with the user device 112 to send and receive data without the need for the network 108 and/or the server 104.

The environment 100 may further include a network 108. The network 108 illustrates an example communication infrastructure in which the connected devices discussed in various embodiments of this disclosure may communicate. The network 108 may be and/or include the Internet, a private network, public network, or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies, such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

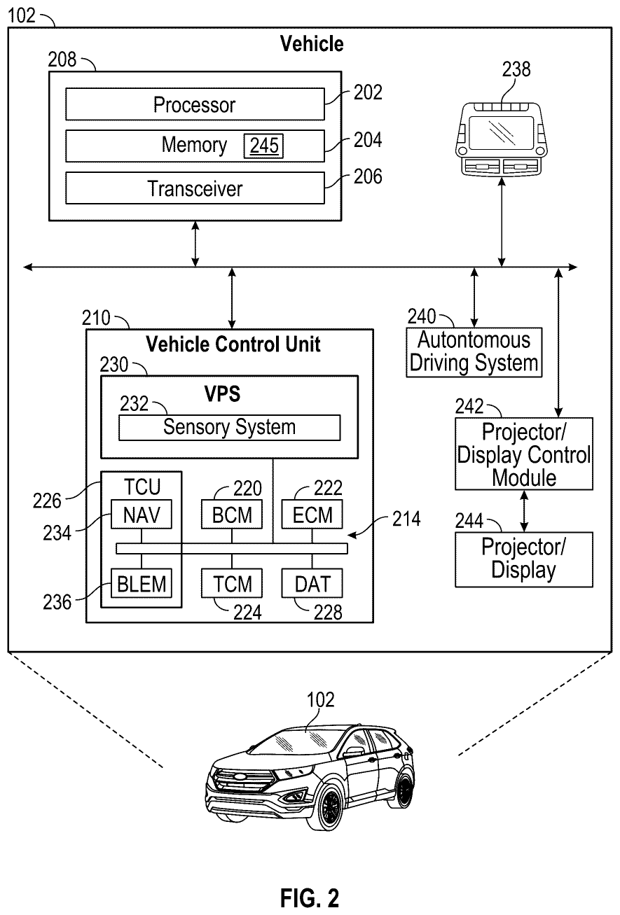

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 that are in communication with the automotive computer 208.

In some embodiments, a user device, such as a mobile phone, a laptop computer, a smart fob, or the like, may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be disposed in communication with one or more memory devices that are in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc., to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power and/or communications bus with the automotive computer 208 and may be configured and/or programmed to coordinate the data between vehicle systems, connected servers, and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistance Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more configurations. For example, the various sensors of the vehicle sensory system 232 may be integrated into the various subsystems of the vehicle 102, such as doors, mirrors, roof, etc., or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102, while a sensor that can monitor an area to any side of the vehicle 102 may be mounted or integrated into the doors of the vehicle 102. Vehicle sensory system 232 may also include one or more road noise sensors, such as accelerometers that are coupled to various mechanical components and/or systems of the vehicle 102. One skilled in the art will realize that the sensors may be coupled with the vehicle in various ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and offboard the vehicle 102 and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a wired or wireless bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), wipers, door locks and access control, various comfort controls, etc. The BCM 220 also may operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 also may provide aspects of user and environmental inputs that are usable for user authentication.

In some embodiments, the automotive computer 208 may connect with an infotainment system 238 (or a vehicle Human-Machine Interface (HMI)). The infotainment system 238 may include a touchscreen interface portion and voice recognition features, biometric identification capabilities that may identify users based on facial recognition, voice recognition, fingerprint identification, or other biological identification means. In other aspects, the infotainment system 238 may be further configured to receive user instructions via the touchscreen interface portion and/or output or display notifications, navigation maps, etc. on the touchscreen interface portion. In some embodiments, the user device 112 may provide the HMI interface.

The vehicle 102 also may include a display control module 242 and an associated display device 244. The display control module 242 may include input/interface components, one or more processing units, a control logic, signal processing components, a power management unit, a display driver unit, and a sensor communication module. The input/interface components may handle communication between the display control module 242 and external devices, such as the user device 112 and/or the control server 104. The input/interface components may include input ports such as HDMI™, VGA, DisplayPort™, USB, MIPI, DSI, LVDS, and/or Embedded DisplayPort ports for video and data input. The interface components may handle communication to and from the display control module 242 using protocols like I2C, SPI, UART, or CAN bus. The input components also may include a memory buffer that may temporarily store incoming image data or instructions before processing.

The display control module 242 may include one or more processing units such as Microcontrollers (MCUs), Graphics Processing Units (GPUs), and memory. These components may manage control logic, frame timing, and signal processing, handle advanced image rendering, transformations, and animations, process raw image data to apply scaling, rotation, gamma correction, color conversion, etc., and temporarily store image data, video frames, and control logic. The control logic may provide synchronization and display timing. The control logic may include a timing controller that may synchronize incoming data with the display's refresh rate and scan order and convert frame data into pixel-by-pixel drive signals, a frame buffer that may store one or more frames of image data to synchronize with the refresh rate of the display, and refresh rate control that adjusts the refresh rate (e.g., 60 Hz, 120 Hz) to ensure smooth image transitions. The signal processing components of the display control module 242 may include data converters (e.g., analog-to-digital (ADC) or digital-to-analog (DAC) converters), color space converter, gamma correction module, and pixel clock generator. The power management unit ensures that the display control module 242 receives the appropriate voltage, current, and power and may include voltage regulators, DC-DC converters, power sequencing logic, and energy management systems.

The display driver unit of the display control module 242 may include display drivers that may send low-level signals to drive individual pixels in a display panel. The display driver can be a row/column driver or individual pixel driver, back light control driver, dimming control driver, and contrast control driver. The sensor communication module can support various types of sensors associated with the display device 244. These sensors may include ambient light sensor, touch screen controller/sensor, proximity sensor, temperature sensor, and the like. The display control module 242 also may include firmware/software running on one or more processing units.

The display device 244 may include a projector/micro-projector, a Liquid Crystal Display (LCD), a Light Emitting Diode (LED) Display, an Organic Light Emitting Diode (OLED) display, a Quantum Dot Display (QLED) display, a MicroLED display, an Electroluminescent Display (ELD), a Plasma Display Panel (PDP), an Electrophoretic Display (EPD), a Cholesteric Liquid Crystal Display (ChLCD), a Cathode Ray Tube (CRT), Projection Displays (such as Digital Light Processing (DLP), Liquid Crystal on Silicon (LCoS), etc.), a transparent display, an Autostereoscopic display, a holographic display, and the like. In some embodiments, the display control module 242 and the display device 244 may be integrated together into a single unit.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In addition to the components noted above, the vehicle 102 may have numerous mechanical systems and sub-systems. A chassis, frame, or unibody may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 also may include a transmission system. The transmission system transfers the engine's power to the wheels. It includes the clutch, gearbox, driveshaft, and differentials, among other components. The transmission adjusts the power output to suit the vehicle's speed and load. The vehicle 102 also may include a suspension system. The suspension system absorbs shocks and maintains contact between the tires and the road, providing a smooth ride. It includes components such as springs, shock absorbers, and linkages. The vehicle 102 also includes a vehicle-stopping system that allows the driver to slow down or stop the vehicle 102. It includes components like pedals, master cylinders, lines, and pads or shoes. The vehicle 102 also includes a steering system that enables the driver to guide the car. The steering system includes components such as the steering wheel, steering column, rack and pinion, and tie rods. The vehicle 102 also may include an exhaust system that removes and filters the waste gases produced by the engine. It includes the exhaust manifold, catalytic converter, muffler, and tailpipe, among other components. The vehicle 102 also includes a cooling system that prevents the engine and/or battery from overheating. It includes components such as the radiator, water pump, thermostat, and coolant. The vehicle 102 also includes a cooling system that stores and supplies fuel to the engine. It includes the fuel tank, fuel pump, fuel filter, and fuel injectors. An electrical system of the vehicle 102 powers the car's electrical components. It may include the battery, alternator, starter motor, and wiring. The Heating, Ventilation, and Air Conditioning (HVAC) system controls the temperature inside the vehicle 102. It includes the heater core, blower motor, and air conditioning compressor. In some embodiments, the vehicle may be an electric vehicle (EV) or hybrid vehicle, and in either case, some of the aforementioned components would be replaced by an electric motor and a high-voltage battery. All of the mechanical components working together ensure that the vehicle 102 operates optimally.

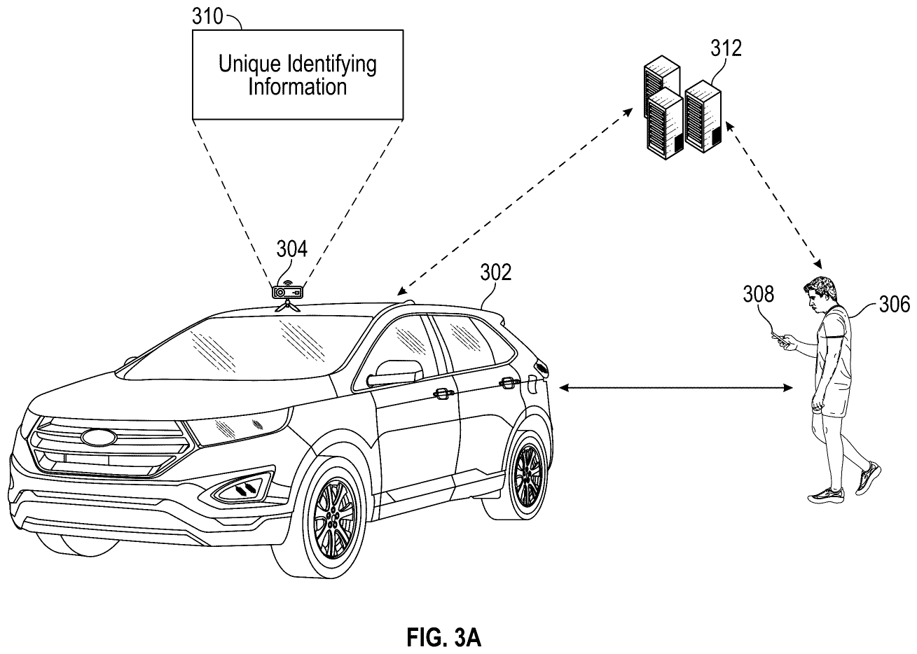

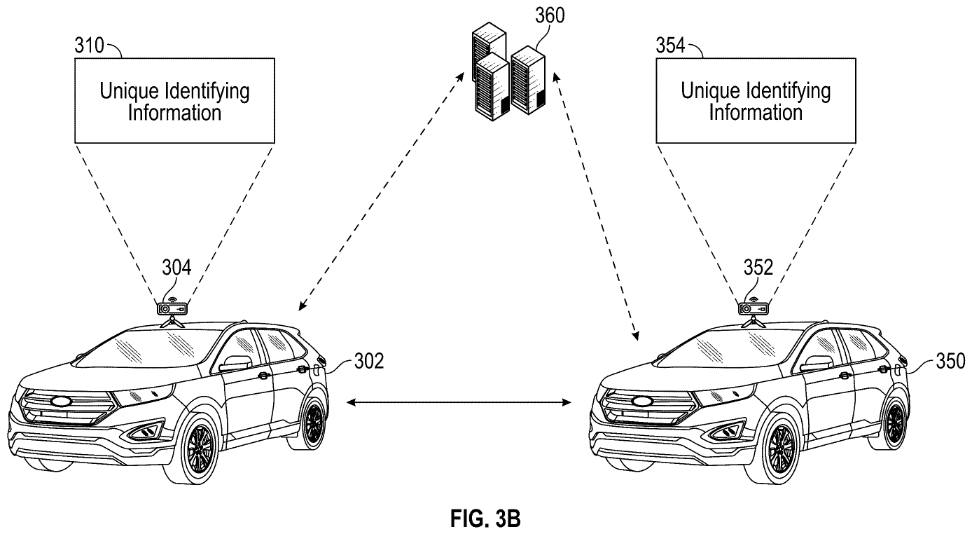

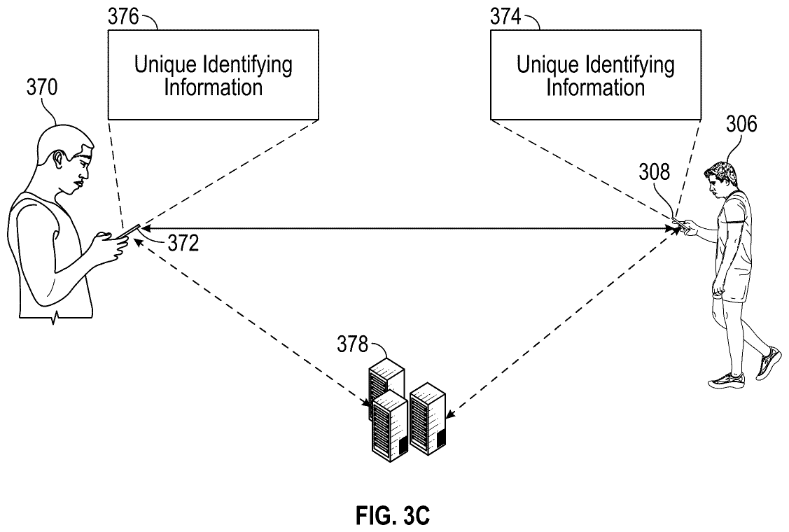

FIG. 3A illustrates an example environment/scenario in which the embodiments of the present disclosure may be implemented. In this example, consider that a user 306 is trying to find a specific vehicle 302. For instance, the user 306 may have requested a ride via a ride hail service at an airport and is attempting to locate the correct vehicle assigned by the ride hail service provider. In another instance, the user 306 may be trying to locate the specific vehicle 302 in a crowded parking lot. The vehicle 302 may belong to someone other than the user 306 and hence the user may be unfamiliar with the vehicle 302. In these and similar circumstances, it may be useful to provide the user 306 with some type of visual indication that would help the user 306 easily locate the vehicle 302.

In an embodiment, the vehicle 302 may be implemented using the vehicle 102 of FIG. 2. The vehicle 302 may include a display device 304 (e.g., the display device 244 of FIG. 2.). The display device 304 may be configured to output a visual indication that is visible from outside of the vehicle and from a threshold distance. In one embodiment, the display device 304 may be coupled with the vehicle 302 such that the display device 304 is able to project or otherwise output a visual indication 310 that resides above the vehicle 302 and is visible from at least a threshold distance from the vehicle 302. In another embodiment, the display device 304 may be configured to present or output the visual indication 310 on one or more surfaces of the vehicle 302 (e.g., a window, a door, a windscreen, etc.) such that the user 306 can see the visual indication 310 from at least a threshold distance from the vehicle 302. In one embodiment, the visual indication 310 may be displayed over the top of the vehicle 302 and separated from the top of the vehicle by a distance, such as, a holographic image projected over the top side of the vehicle 302. One skilled in the art will realize that there are many ways of coupling the display device 304 to the vehicle 302 such that the output of the display device 304 is visible from outside of the vehicle and the specific methods or ways of coupling the display device 304 to the vehicle 302 will depend on the type of the display device 304 and/or the type of the vehicle 302.

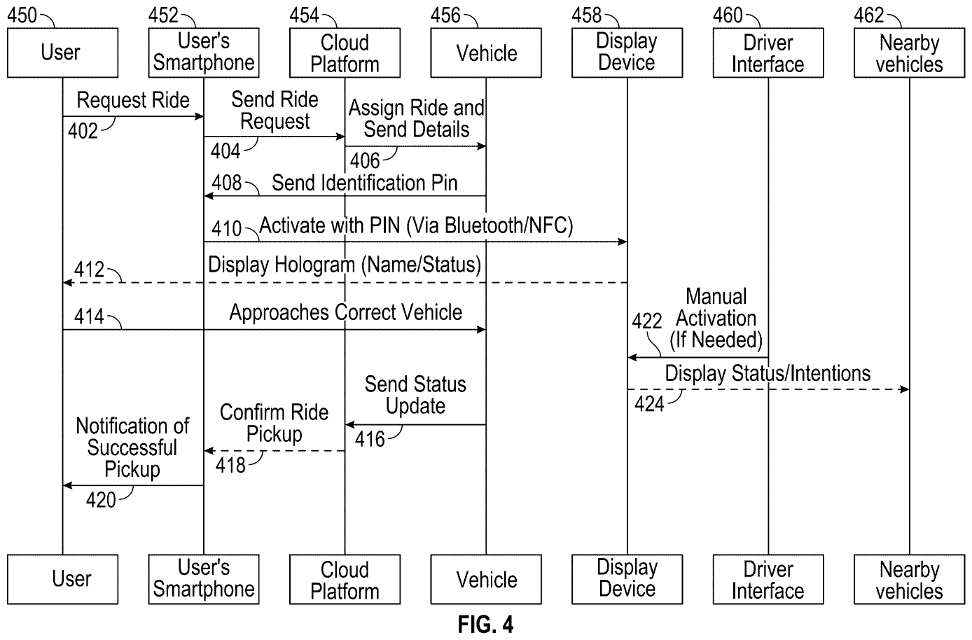

The visual indication 310 may include unique identifying information that is known only to the user 306 and the vehicle 302 (or the operator of the vehicle 302). The details of how the visual indication 310 is generated and displayed is provided below with reference to FIG. 4-7 below. In operation, when the user 306 is within a threshold distance of the vehicle 302, the user 306 may send a message to the vehicle via the user device 308. Based on the message, the vehicle 302 either may generate the unique identifying information or may receive the unique identifying information from the user device 308. Thereafter, the vehicle 302 may output the visual indication 310 that includes the unique identifying information. The user 306 can then use the unique identifying information to locate the vehicle 302. The unique identifying information can include one or more of: text, colors, holographic image, visual patterns, images, video, or a combination thereof.

In some instances, the vehicle 302 may establish a communication session with the user device 308 once the user device 308 is within a threshold distance or vicinity of the vehicle 302. The threshold distance can be programmed by the operator of the vehicle 302 and can range between a few feet to a few meters. In an embodiment, the threshold distance can be dependent on the communication protocol being used by the vehicle 302 and the user device 308 to communicate with each other. For example, if a short-range communication protocol, such as personal area network (PAN) protocol, is used the threshold distance may be less than if a long-range communication protocol, such as Wi-Fi or similar is being used. In other embodiments, the communication session between the vehicle 302 and the user device 308 may not be dependent on a physical distance between them. For example, the user device 308 and the vehicle 302 may communicate with each other via an external server 312 (e.g., server 104 of FIG. 1). In this instance, the communication session between the vehicle 302 and the user device 308 may be established even if the user device 308 is not within the vicinity of the vehicle 302. Once the communication session is established, the vehicle 302 and the user device 308 can exchange data with each other.

In an embodiment, the user device 308 may communicate with the vehicle 302 via an application resident on the user device 308. For example, in the ride hail service example above, the ride hail service operator may send the vehicle details to the user device 308. Once the vehicle 302 is in the vicinity of the user device 308, the user 306 may send a message to the vehicle 302 via a ride share application on the user device 308. Once the vehicle 302 receives the message, the vehicle may output the unique identifying information that is visible to the user 306. In other instances, the user device 308 may send a message or a command to activate a display control module (e.g., display control module 242 of FIG. 2) to cause the display control module to output the unique identifying information. In some instances, the user device 308 may send a randomly generated unique identifying information to the vehicle 302, and the vehicle may then output randomly generated unique identifying information, which only the user recognizes. This will enable the user 306 to correctly identify the vehicle while the unique identifying information may not mean anything to other users in the vicinity and may be ignored by the other users. In other embodiments, the ride hail service operator (e.g., the server 312) may generate the unique identifying information and send that information to the vehicle 302 and the user device 308. In this manner, only the vehicle 302 and the user device 308 are privy to the unique identifying information.

In other embodiments, the user 306 may display the unique identifying information 310 via the user device 308 (e.g., by projecting the unique identifying information 310 via the user device 308). The vehicle 302 may detect and recognize the unique identifying information 310 and autonomously move towards the user device 308. In this manner, the vehicle 302 may find the user 306 instead of the user 306 finding the vehicle 302.

FIG. 3B illustrates another environment/scenario in which embodiments of the present disclosure can be implemented. In this instance, consider that users travelling in two different vehicles 302 and 350 plan to meet at a particular location. The location may be a parking lot of an event venue, a transportation hub, or the like where multiple vehicles are likely to be present and finding the correct vehicle may be difficult. In this embodiment, once the two vehicles 302 and 350 are within a threshold distance of each other, a communication session may be established between the two vehicles using any of the above-described communication protocols. Once the communication session is established, both the vehicles 302 and 350 may output visual indicators 310 and 354 that each display unique identifying information. In one embodiment, both vehicles 302 and 354 may output identical unique identifying information. In another embodiment, each vehicle may output a different unique identifying information. In this instance, each of the vehicles 302 and 352 may send their respective unique identifying information to the other vehicle. The receiving vehicle may display the received unique identifying information on a display of the vehicle and/or on a user device of the user in the receiving vehicle. In this manner, the users in the receiving vehicle can use the received unique identifying information to locate the sending vehicle.

In one instance, the vehicles 302 and 350 may exchange data using the vehicle-to-vehicle (V2V) communication without the need for any external entity. In other embodiments, the vehicles 302 and 350 may communicate with each other using an external server 360 (e.g., using the vehicle-to-infrastructure (V2X) communication methods). In an embodiment, the external server 360 may generate the unique identifying information and send the unique identifying information to both the vehicles 302 and 350. In another embodiment, one of the vehicles may generate the unique identifying information and send it to the other vehicle and both the vehicles then output the unique identifying information. In yet another embodiment, each vehicle generates its own unique identifying information and sends it to the other vehicle. Each vehicle then may output its own unique identifying information that the vehicle has generated.

FIG. 3C illustrates yet another environment/scenario in which embodiments of the present disclosure can be implemented. Similar to the scenario of FIG. 3B, the device-to-device communication can be extended to enable two users 306 and 370 to locate each other in a crowded location. For example, consider that two users 306 and 370 would like to meet at a particular location, such as a sporting or musical event. These locations typically are characterized by large gatherings involving thousands to tens of thousands of people. Finding and locating a particular person in this crowd can be challenging. In this instance, once the user device 308 and the user device 372 are within a certain distance of each other, each of the user devices 308 and 372 can output a respective visual indicator 374 and 376 that each displays unique identifying information. The visual indicators 374 and 376 may be displayed such that each of the users 306 and 370 can locate each other from a distance. In an embodiment, each of the users' devices 308 and 372 may output a holographic image that is visible to other users from a distance. Since the unique identifying information displayed via the visual indicators 374 and 376 is known a priori to each of the users 306 and 370, the two users can easily and reliably locate each other even in the crowded environment. As in the previous examples, the two user devices 308 and 372 may communicate directly with each other without any intervening entity or may communicate with each other via an external server 378. In some embodiments, the unique identifying information output by each user device 308 and 372 may be identical or different.

FIG. 4 illustrates a data flow sequence of a process for enabling a user to locate a vehicle according to an embodiment of the present invention. FIG. 4 uses an example of a user locating his/her ride share vehicle to explain the embodiments of the present invention. However, it is to be understood that the dataflow is also applicable to other scenarios in which a user may need to locate a specific vehicle for any purpose.

The process may start with a user 450 inputting information 402 via his/her user device 452 to request a ride share service. The user device 452 may communicate that ride share request 404 to server 454 of the ride share service provider. In response to receiving the ride share request 404, the server 454 may determine an appropriate vehicle 456 to service the request and send the ride share request details 406 to the vehicle 456. The server then may send information about the vehicle 456 to the user device 452 along with access information to remotely activate a display control module of the vehicle 456 (408). The access information may be in the form of a personal identification number (PIN), passphrase, passcode, electronic key, or the like. Once the vehicle 456 is in the vicinity of the user device 452, the user device 452 may get a notification that the vehicle is nearby. For example, the server 454 may track the user device 452 location and the location of the vehicle 456 to determine that the vehicle is within the vicinity or threshold distance of the user device 452. Upon receiving the notification that the vehicle 456 is within a threshold distance of the vehicle 456, the user 450 may send a message 410 to the vehicle 456 via the user device 452 to activate the display control module of the vehicle 456. Upon receiving the message, the vehicle 456 may activate a display device 458 coupled to the display control module and output a visual indicator (412) that is visible from outside the vehicle and at the threshold distance from the vehicle 456. The visual indicator may include unique identifying information that is only known to the user 450 and the vehicle 456. The user 450 then may locate the vehicle 456 by recognizing the unique identifying information (414).

The unique identifying information may be generated in several ways. In one instance, the user device 452 may generate the unique identifying information and send that information to the vehicle as part of the message 408 to activate the display control module of the vehicle 456. The vehicle then displays the unique identifying information received from the user device 452. In another instance, the vehicle 456 may generate the unique identifying information and send that information to the user device 452. The vehicle then may output that unique identifying information via the display device 458 and the user can identify the vehicle 456 using the unique identifying information. In yet another instance, the server 454 may generate the unique identifying information and send the information to both the vehicle 456 and the user device 452. In all these instances, the user device 452 sends a command/message (410) to activate the display control module of the vehicle 456 to cause the vehicle to display the unique identifying information. In this manner, the user 450 is in control of when the vehicle outputs the unique identifying information since the user 450 is in the best situation to determine when he/she can visually locate the vehicle 456.

Once the user 450 has located the vehicle and started the ride, the vehicle 456 may send a status update message 416 to the server 454. The server 454 then may send a confirmation of the ride pick-up 418 to the user device 452, which can be read (420) by the user 450. In some embodiments, the driver of the vehicle 456 may manually activate (422) the display control module via a vehicle interface 460 to cause the display device 458 to output status and other data (424). The status and other data may be recognized by other vehicles 462 in the vicinity of the vehicle 456.

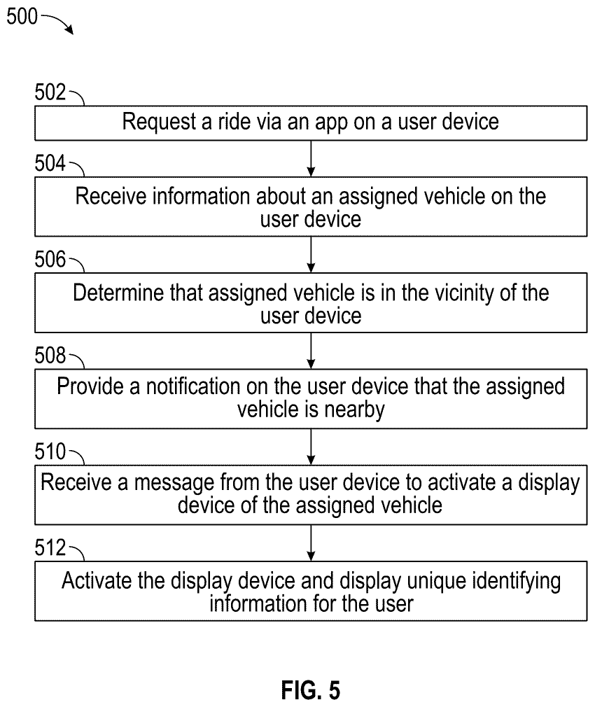

FIG. 5 illustrates a flow diagram of a process 500 according to an embodiment of the present invention. The process 500 may be performed by a vehicle or the vehicle in conjunction with a remote server (e.g., vehicle 302/102 solely or in conjunction with the server 312/104). At step 502, a user may request a ride via his/her user device. The vehicle/remote server may receive the ride request. Upon receiving the ride request, a vehicle is identified and assigned to service the ride request at step 504. The vehicle for fulfilling the ride request may depend on several factors such as vehicle availability, origin and destination of the ride, number of users, etc. Once a vehicle is identified and assigned to fulfill the ride request, the information about the vehicle may be sent to the user device. At some point in time, it may be determined that the vehicle is in the vicinity/threshold distance of the user device (step 506). For example, this can be accomplished by comparing the current locations of the user device and the vehicle. At step 508, a notification may be provided to the user device informing the user that the assigned vehicle is in the vicinity of the user. Upon receiving the notification, the user may send a message/command via the user device to the vehicle. The message is associated with activating a display control module of the vehicle. The vehicle receives the message from the user device at step 510. Upon receiving the message, the vehicle may operate a display device of the vehicle, via the display control module, to output a visual indication that is visible from outside the vehicle, at step 512. The visual indication includes unique identifying information that is only known to that particular user and no other user in the same location. The user then may use the unique identifying information to accurately locate the vehicle. The unique identifying information may be generated by the vehicle upon receiving the message at step 510, or the user device may send the unique identifying information to the vehicle as part of the message to activate the display control module, or the remote server may generate the unique identifying information and send it to the vehicle and to the user device.

While the process 500 above is explained in a ride hail request context, it is to be understood that this is only exemplary, and the process 500 is applicable in any situation in which a user may need to identify and locate the correct vehicle from among multiple vehicles.

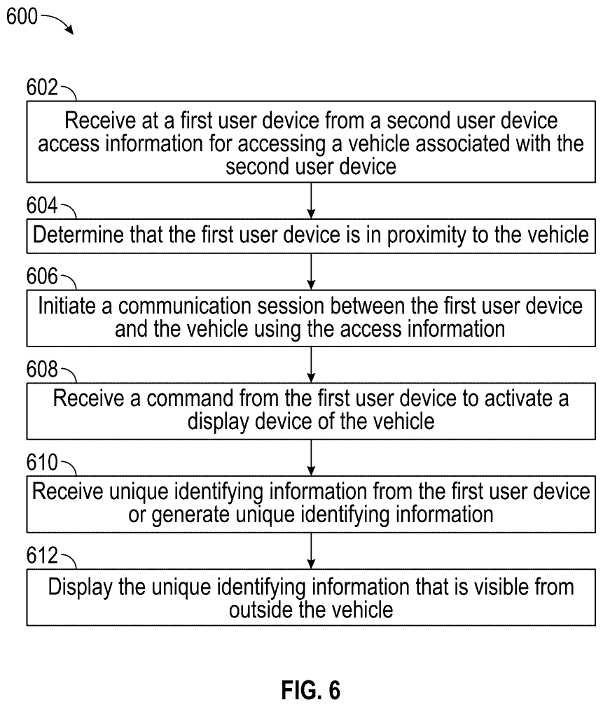

FIG. 6 illustrates a flow diagram for a process 600 according to another embodiment of the present disclosure. The process 600 may be used in instances where a user may want to locate a specific vehicle from among a plurality of vehicles. Consider a scenario in which a user wants to locate a vehicle that belongs to another user and is parked in a crowded parking lot. In this instance, the first user may receive a message on his first user device from a second user device of the second user at step 602. The message may include access information associated with the vehicle. For example, the access information may include a PIN, network details, or other information that may enable the first user device to establish a communication session with the vehicle. Upon receiving the message from the second user device, the first user may proceed to locate the vehicle. As the first user gets to within a threshold distance of the vehicle, either the vehicle, the first user device, or both may determine that the first user device and the vehicle are within a threshold distance of each other (step 604).

Based on that determination, the first user device and/or the vehicle may initiate and establish a communication session between the first device and the vehicle at step 606. For example, the first user device may use the access information received from the second user device to initiate and establish the communication session. Once the communication session is established, the vehicle may receive a message/command from the first user device to activate a display control module of the vehicle, at step 608. Concurrently or subsequent to receiving the message/command, the vehicle, via the display control module, may also receive unique identifying information from the first user device, at step 610. In other embodiments, the vehicle may generate the unique identifying information after receiving the message/command at step 608. The vehicle may then output a visual indication that displays the unique identifying information at step 612. The visual indication is visible from outside the vehicle and at least from the threshold distance. The first user may then use the unique identifying information to locate the vehicle.

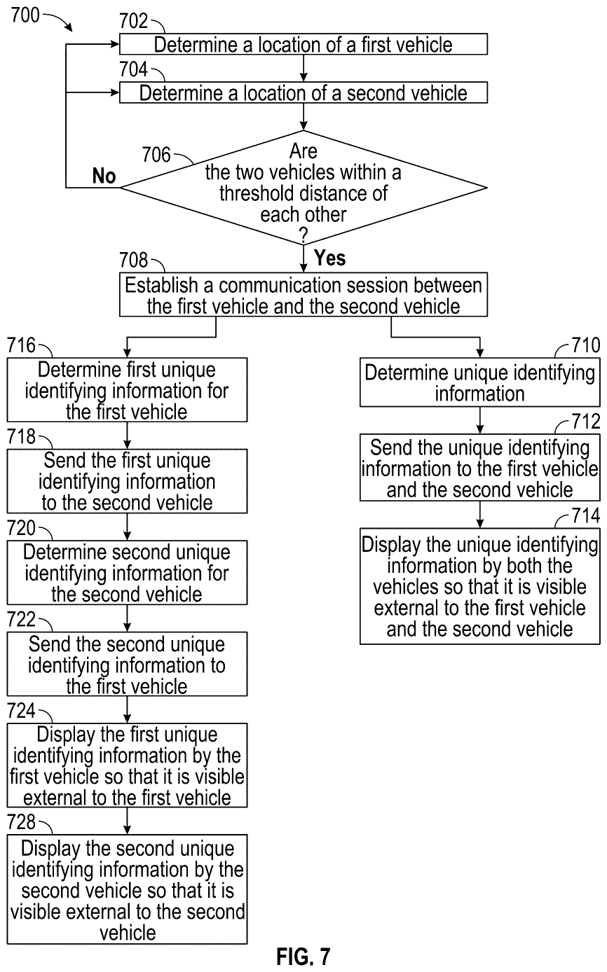

FIG. 7 illustrates a flow diagram of a process 700 according to yet another embodiment of the present disclosure. The process 700 illustrates a scenario in which occupants of two different vehicles can identify the other vehicle from among multiple vehicles. For example, consider a scenario in which two groups of friends travelling in different vehicles want to meet in a parking lot of a venue. The first group of friends is travelling in a first vehicle, and the second group of friends is travelling in a second vehicle. The process 700 may be performed by the respective vehicles (e.g., vehicles 302 and 350 of FIG. 3B) or the vehicles in conjunction with a remote server (e.g., server 104/360).

At step 702, a first location of the first vehicle is determined. The first location may be determined using the geo-spatial information associated with the vehicle and captured by one or more geo-spatial sensors of the first vehicle. At step 704, a second location of the second vehicle is determined using a similar process as that for the first vehicle. Based on the first location information and the second location information, it may be determined whether the first vehicle and the second vehicle are within a threshold distance of each other (step 706). The threshold distance may be pre-determined and can range between a few feet to hundreds of feet. The threshold distance may be determined keeping in mind that the goal is to enable the users of both the vehicles to visually identify the other vehicle. So, a large value (e.g., hundreds of meters) for the threshold distance is likely not practical for this purpose. If at step 706 it is determined that the first vehicle and the second vehicle are not within the threshold distance of each other, the process 700 may return back to steps 702 and 704 and the current locations of the two vehicles may be monitored periodically.

If at step 706, it is determined that the first vehicle and the second vehicle are within the threshold distance of each other, a communication session may be established between the first vehicle and the second vehicle at step 708. Thereafter, the process 700 may take one of two paths. In the first path, a first unique identifying information may be determined for the first vehicle at step 716. The first unique identifying information may be generated by the first vehicle or a remote server that is in communication with the first vehicle. At step 718, the first unique identifying information may be sent to the second vehicle. This may be done in one of two ways. First, the first vehicle may directly send the first unique identifying information to the second vehicle via V2V communication or second, the first vehicle may send the first unique identifying information to the remote server, and the remote server then may send the first unique identifying information to the second vehicle (e.g., using V2X communication).

At step 720, a second unique identifying information may be determined for the second vehicle. The second unique identifying information may either be determined by the second vehicle or by the remote server that is in communication with the second vehicle. At step 722, the second unique identifying information may be sent to the first vehicle. This may be done in one of two ways. First, the second vehicle may directly send the second unique identifying information to the first vehicle via V2V communication or second, the second vehicle may send the first unique identifying information to the remote server, and the remote server then may send the first unique identifying information to the first vehicle (e.g., using V2X communication). After the first vehicle receives the second unique identifying information, it may display the second unique identifying information on its HMI unit, so the occupants of the first vehicle know what information is to be used to identify the second vehicle. Similarly, after the second vehicle receives the first unique identifying information, it may display the first unique identifying information on its HMI units, so occupants of the second vehicle may know what information is to be used to identify the first vehicle. In some embodiments, in addition to or in lieu of displaying the first/second unique identifying information on their respective HMI units, the respective vehicle may send the first/second unique identifying information to a user device of one or more occupants of the respective vehicles.

At step 724, the first vehicle may output a first visual indication (e.g., using a display device as explained above) including the first unique identifying information such that the first unique identifying information is visible from outside the first vehicle and at or less than the threshold distance. At step 728, the second vehicle may output a second visual indication (e.g., using a display device as explained above) including the second unique identifying information such that the second unique identifying information is visible from outside the second vehicle and at or less than the threshold distance. The occupants of the first vehicle can then use the second unique identifying information to identify and locate the second vehicle, and the occupants of the second vehicle can then use the first unique identifying information to identify and locate the first vehicle. In this instance, the first unique identifying information and the second unique identifying information may be different and may be generated by the respective vehicle using one or more of: true random number generators, Pseudo-Randon Number Generators, random string generators, N-grams, Context-free Grammars (CFGs), syllable-based generation, phonotactic rule-based generators, random geometric shapes and patterns, etc. In other instances, the first vehicle and the second vehicle may communicate and generate shared secret information. This shared secret information then may be displayed by both the first vehicle and the second vehicle. In yet another embodiment, one of the two vehicles may generate the unique identifying information and send it to the other vehicle. Thereafter, both the vehicles may then output the same unique identifying information.

The process 700 also may take a second path after the communication session is established between the two vehicles at step 708. In addition to direct communication between the first vehicle and the second vehicle, each of the first vehicle and the second vehicle also may be communicably coupled with a remote server (e.g., remote server 104/360). At step 710, the remote server may determine unique identifying information using any of the methods and systems described above. Thereafter, at step 712, the remote server may send the unique identifying information to the first vehicle and the second vehicle. Upon receiving the unique identifying information, each of the first vehicle and the second vehicle may output the unique identifying information, at step 714. In an embodiment, the respective vehicle also may display the unique identifying information on its respective HMI unit for the benefit of the occupants of the respective vehicle. In other embodiments, each vehicle and/or the remote server may send the unique identifying information to a user device of one or more occupants of the two vehicles. The occupants of the two vehicles may then easily identify and locate the other vehicle using the unique identifying information.

While the above embodiments are described in the context of one or two vehicles and one or two user devices, it is to be understood that the embodiments described above are equally applicable in scenarios that involve more than two vehicles and/or more than two user devices.

FIG. 8 depicts a block diagram of an example control server 800 (e.g., control server 104 of FIG. 1) upon which any of one or more techniques (e.g., methods) may be performed or which may perform the methods described above in conjunction with the vehicle 102, in accordance with one or more example embodiments of the present disclosure. In other embodiments, the server 800 may operate as a standalone device or may be connected (e.g., networked) to other servers. In a networked deployment, the server 800 may operate in the capacity of a server machine, a client machine, or both in server-client network environments. In an example, the server 800 may act as a peer server in peer-to-peer (P2P) (or other distributed) network environments. The server 800 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The server 800 may further include a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The server 800 additionally may include a storage device (i.e., drive unit) 816, a network interface device/transceiver 820 coupled to antenna(s), and one or more sensors 828, such as a global positioning system (GPS) sensor, a compass, an accelerometer, or another sensor. The server 800 may include an output controller 834, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 816 may include a machine-readable medium 822 on which is stored one or more sets of data structures or instructions (e.g., software) embodying or utilized by any one or more of the techniques or functions described herein. The instructions also may reside, completely or at least partially, within the main memory 804, within the static memory 806, or within the hardware processor 802 during execution thereof by the server 800. In an example, one or any combination of the hardware processor 802, the main memory 804, the static memory 806, or the storage device 816 may constitute machine-readable media.

While the machine-readable medium 822 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as, but not limited to, read-only memory (ROM) random access memory (RAM), magnetic disk storage media, optical storage media, a flash memory, etc.

The term “machine-readable medium” may include any medium that is capable of storing, encoding, or carrying instructions for execution by the server 800 and that causes the server 800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 800 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner's manual and safety guidelines. In addition, any action taken by the vehicle owner/driver based on recommendations or notifications provided by the vehicle should comply with all the rules specific to the location and operation of the vehicle (e.g., federal, state, country, city, etc.). The recommendations or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. For example, one or more application-specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should also be understood that the word “example” as used herein, is intended to be non-exclusionary and non-limiting in nature. More particularly, the word “example” as used herein, indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices, such as those listed above, and stored on a computer-readable medium.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined not with reference to the above description but should instead be determined with reference to the appended claims, along with the full scope of equivalents to which such claims are entitled. It is anticipated and intended that future developments will occur in the technologies discussed herein and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
determining a first location of a vehicle;
determining a second location of a user device;
determining, based on the first location and the second location, that the vehicle and the user device are within a threshold distance of each other;
determining unique identifying information; and
outputting, via a display device of the vehicle, a visual indication that can be seen from outside the vehicle, the visual indication including the unique identifying information.

2. The method of claim 1, further comprising, prior to outputting the visual indication:
receiving, by the vehicle from the user device, a message to activate a display control module of the vehicle; and
activating, by the vehicle and based on the message, the display control module;
wherein outputting the visual indication includes operating, by the display control module, the display device.

3. The method of claim 2, wherein determining the unique identifying information includes receiving the unique identifying information from the user device.

4. The method of claim 1, wherein the unique identifying information includes one or more of:
textual information;
a light pattern;
one or more images;
video data;
a holographic image; or
alpha-numeric data.

5. The method of claim 1, further comprising:
receiving, by the user device from a second user device, access information associated with the vehicle, wherein the second user device is associated with an owner of the vehicle;
subsequent to determining that the vehicle and the user device are within the threshold distance of each other, establishing a communication session between the user device and the vehicle using the access information.

6. The method of claim 1, wherein determining the unique identifying information further comprises:
determining, by the vehicle, the unique identifying information.

7. The method of claim 1, wherein outputting the visual indication further comprises:
positioning, by the display device, the visual indication above a top of the vehicle.

8. A method comprising:
determining a first location of a first vehicle;
determining a second location of a second vehicle;
determining, based on the first location and the second location, the first vehicle and the second vehicle are within a threshold distance of each other;
establishing a communication session between the first vehicle and the second vehicle;
outputting, by the first vehicle, a first visual indication including first unique identifying information that is visible from outside of the first vehicle; and
outputting, by the second vehicle, a second visual indication including second unique identifying information that is visible from outside of the second vehicle.

9. The method of claim 8, further comprising:
receiving, by the first vehicle from a remote server, the first unique identifying information; and
receiving, by the second vehicle from the remote server, the second unique identifying information.

10. The method of claim 8, wherein the first unique identifying information and the second unique identifying information are identical.

11. The method of claim 8, wherein outputting the first visual indication further comprises:
operating, by the first vehicle, a first display device of the first vehicle, the first display device configured to project the first visual indication above a top of the first vehicle.

12. The method of claim 8, further comprising:
generating, by the first vehicle, the first unique identifying information;
generating, by the second vehicle, the second unique identifying information;
sending, by the first vehicle to the second vehicle, the first unique identifying information; and
sending, by the second vehicle to the first vehicle, the second unique identifying information.

13. The method of claim 12, wherein the first unique identifying information and the second unique identifying information are different.

14. The method of claim 8, further comprising:
determining, by a remote server, the first and the second unique identifying information;
sending, by the remote server, the first unique identifying information to the first vehicle; and
sending, by the remote server, the second unique identifying information to the second vehicle.

15. A vehicle comprising:
a controller;
a display control module coupled to the controller;
a display device coupled to the display control module;
one or more sensors coupled to the controller; and
a memory device coupled to the controller and storing instructions that, when executed by the controller, causes the controller to:
determine, using the one or more sensors, a first location of the vehicle;
receive, at the first location, a message from a user device to activate the display control module;
activate, based on the message, the display control module; and
output, based on the message and using the display device, a visual indication that can be seen from outside the vehicle, the visual indication including unique identifying information.

16. The vehicle of claim 15, wherein the message further includes the unique identifying information.

17. The vehicle of claim 15, wherein the instructions further cause the controller to: determine, based on the first location, that the vehicle is within a threshold distance of the user device.

18. The vehicle of claim 15, wherein the instructions further cause the controller to:
receive, based on the first location, the unique identifying information from a remote server communicably coupled with the vehicle and the user device.

19. The vehicle of claim 15, wherein the instructions further cause the controller to generate the unique identifying information.

20. The vehicle of claim 15, wherein the instructions further cause the controller to operate the display control module to cause the display device to position the visual indication above a top of the vehicle.
